(19) United States
(12) Patent Application Publication
(10) Pub. No.: US 2012/0121018 A1
(43) Pub. Date: May 17, 2012

(54) Generating Single-Slice Pictures Using Paralellel Processors

(75) Inventors: George J. Kustka, Marlboro, NJ (US); John T. Falkowski, White Haven, PA (US); Zhicheng Ni, Allentown, PA (US)

(73) Assignee: LSI CORPORATION, Milpitas, CA (US)

(21) Appl. No.: 12/948,176

(22) Filed: Nov. 17, 2010

(51) Int. Cl. H04N 7/26; H04N 7/34

(52) U.S. Cl. 375/240.16; 375/240.24; 375/E07.123; 375/E07.026

(57) ABSTRACT

A video encoding system generates (e.g., H.264) single-slice pictures using parallel processors. Each picture is divided horizontally into multiple segments, where each different parallel processor processes a different segment. Each parallel processor (other than the first parallel processor of the uppermost segment) only partially processes the macroblocks in the first row of its segment. Subsequently, a final processor completes the processing of the partially encoded, first-row macroblocks based on the encoding results for the macroblocks in the last row of the segment above and across the segment boundary. The encoding of the first-row macroblocks is constrained to enable the encoding of all other rows of macroblocks to be completed by the parallel processors, without relying on the final processor.

### BACKGROUND

1. Field of the Invention

The present invention relates to signal processing, and in particular to video encoding.

2. Description of the Related Art

This section introduces aspects that may help facilitate a better understanding of the invention. Accordingly, the statements of this section are to be read in this light and are not to be understood as admissions about what is prior art or what is not prior art.

The current H.264 advanced video coding standard of the International Telecommunication Union's Telecommunication Standardization Sector (ITU-T) allows pictures in an incoming, uncompressed video stream to be partitioned into a plurality of slices, where each slice is encoded separately, with minimal dependencies between slices, to generate an outgoing, compressed video bitstream. This slice-based processing enables video encoding to be performed by a plurality of parallel processors (e.g., DSP cores), where each processor encodes a different slice of each picture in the incoming video stream with minimal communication between the processors. Such parallel processing is critical for some applications to enable the video encoding process to keep up with the incoming video stream. Although the current H.264 standard allows slice-based video encoding, there are many legacy H.264 decoders that can handle only single-slice video bitstreams, where each picture is encoded as a single slice.

### SUMMARY

Problems in the prior art are addressed in accordance with the principles of the present invention by providing a video encoding system that can compress an incoming, uncompressed video stream into an outgoing, single-slice, compressed video bitstream using multiple parallel processors to process different segments of each picture in the stream.

In one embodiment, the present invention is a system for encoding single-slice pictures. The system comprises a plurality of initial processors and a final processor. Each initial processor processes a different horizontal segment of a picture, wherein at least one initial processor of a segment in the picture only partially encodes the segment. The final processor completes the encoding of each partially encoded segment to produce a single-slice encoded picture.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 is a block diagram of a video encoding system according to one embodiment of the present invention;

FIG. 2 shows three different modes for predicting pixel data for H.264 I4×4-type macroblocks;

FIG. 3 shows three different modes for predicting pixel data for H.264 I16×16-type macroblocks;

FIG. 4 shows a portion of an exemplary picture containing a current macroblock being encoded;

FIGS. 5 and 6 illustrate some of the constraints applied to upper and lower processors when encoding a predicted picture; and

FIG. 7 illustrates some of the constraints applied to upper and lower processors when encoding a non-predicted picture.

### DETAILED DESCRIPTION

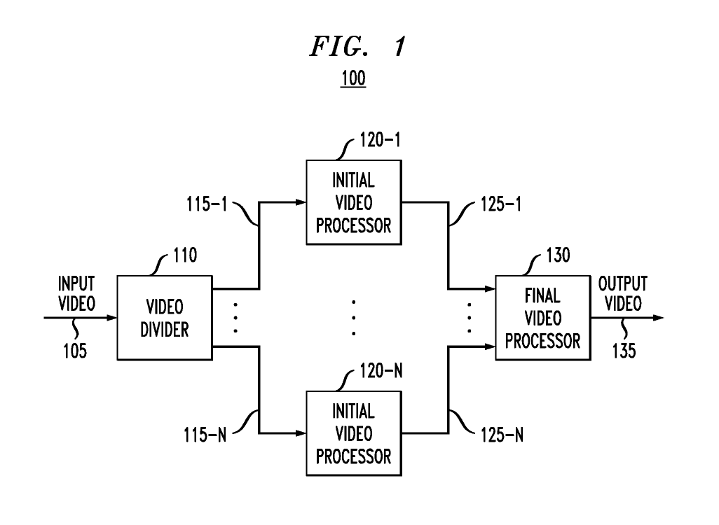

FIG. 1 is a block diagram of video encoding system 100 according to one embodiment of the present invention. Video encoding system 100 receives an incoming, uncompressed video stream 105 and generates an outgoing, single-slice, compressed video bitstream 135.

In particular, video divider 110 divides each picture of the incoming video stream 105 horizontally into N segments 115, where N is an integer greater than one, and each segment 115_{—}i is at least partially encoded by a different initial video processor 120_{—}i. Final video processor 130 receives the partially encoded video data 125_{—}i from each initial video processor 120_{—}i and completes the video encoding processing to generate the outgoing, single-slice, compressed video bitstream 135.

In certain implementations of video encoding system 100, each initial video processor 120 is implemented by a different DSP core, while, depending on the particular implementation, (i) video divider 110 is implemented either by one of the same DSP cores as one of the N initial video processors 120 or by another DSP core and (ii) final video processor 130 is implemented either by one or more of the same DSP cores as one or more of the N initial video processors 120 or by another DSP core, possibly the same DSP core used to implement video divider 110. In one possible implementation, a single integrated circuit includes (i) a host core that performs the functions of both video divider 110 and final video processor 130 and (ii) N slave cores, each of which functions as a different initial video processor 120, where all (N+1) cores are capable of accessing shared memory (not shown in FIG. 1) that is implemented either on chip or off chip or both.

In general, video encoding system 100 employs two different strategies to produce a single-slice output using multiple, parallel, initial video processors 120 to process different horizontal segments of a video picture in an efficient manner. The first strategy is to restrict some of the encoding choices made by some of the initial video processors 120 to restrict dependencies between the different segments. To the extent that certain dependencies remain, those dependencies are limited to narrow strips of picture data located at the boundaries of the picture segments. As such, the video encoding by the initial video processors 120 can be substantially complete for most of the video data in each segment. When the processing by the different initial video processors 120 is complete, the final video processor 130 takes the existing, limited dependencies between picture segments into account to complete the video encoding of the individual segments and combine them into a single-slice, compressed video bitstream. The employment of the final video processor 130 to take the existing, limited dependencies into account constitutes the second strategy employed by video encoding system 100.

The two strategies employed by video encoding system 100 are related in that the restriction of encoding choices enables the initial video processors 120 to complete the processing of all of the video data in their respective picture segments except for some video data located at the top of a (lower) picture segment that is adjacent to the boundary with another (upper) picture segment.

### H.264 Video Encoding Standard

The H.264 standard supports two different types of pictures: predicted pictures and non-predicted pictures. In a non-predicted picture, each (16 pixel×16 pixel) macroblock (MB) is encoded without reference to any other pictures in the video stream. In a predicted picture, each macroblock can be, but does not have to be, encoded with reference to another picture in the video stream. In the H.264 standard, pictures (or picture slices) are typically encoded row by row from left to right starting with the upper left macroblock.

A macroblock that is encoded without reference to another picture is referred to as an intra or I macroblock, while a macroblock that is encoded with reference to another picture is referred to as a predicted macroblock. Predicted macroblocks include P macroblocks (for which encoded pixel data is transmitted) and PSKIP macroblocks (for which encoded pixel data is not transmitted). The H.264 standard supports different modes for encoding intra macroblocks (i.e., intra modes) and different modes for encoding predicted macroblocks (i.e., predicted modes).

In general, in the H.264 standard, macroblocks are encoded by applying a transform (e.g., a (4×4) integer transform) to pixel data, the resulting transform coefficients are then quantized, the resulting quantized coefficients are then run-length encoded, and the resulting run-length codes are then Huffman encoded. Depending on the type of macroblock (i.e., intra or predicted) and the encoding mode for that macroblock type, the pixel data that is subjected to the transform is either pixel difference data or raw pixel data.

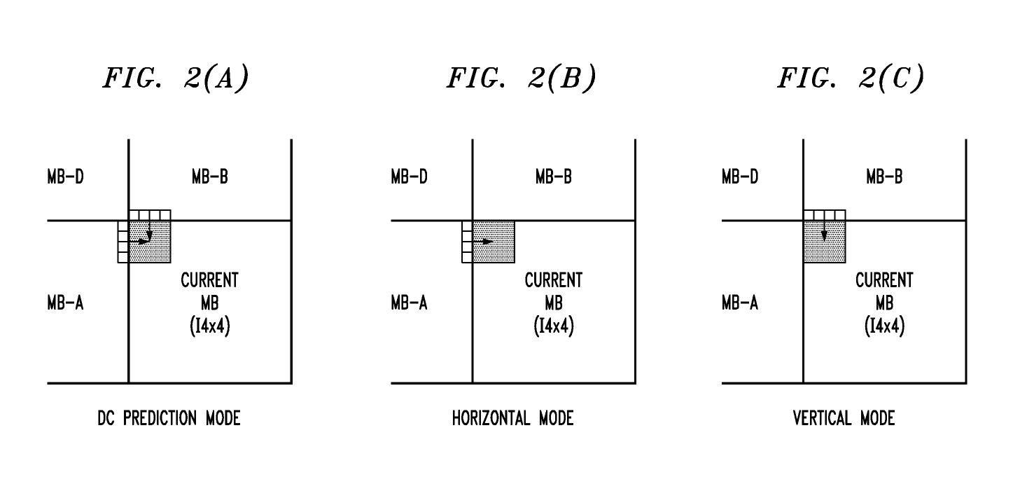

FIG. 2 shows three different modes for predicting pixel data for I4×4-type macroblocks, where the (16×16) macroblock is encoded as sixteen (4×4) blocks of pixels. In particular, FIG. 2(A) illustrates DC prediction mode in which the prediction for the (4×4) block of pixels in the upper left corner of the current macroblock is based on the average of the four adjacent pixels in macroblock MB-A and the four adjacent pixels in macroblock MB-B. Note that, if macroblock MB-B is not available, then DC prediction mode will be based on the average of only the four adjacent pixels in macroblock MB-A. Similarly, if macroblock MB-A is not available, then DC prediction mode will be based on the average of only the four adjacent pixels in macroblock MB-B. If both macroblocks MB-A and MB-B are not available, then DC prediction mode will be based on a default average value (e.g., 128 for 8-bit precision in the H.264 standard).

FIG. 2(B) illustrates horizontal prediction mode in which the prediction for the (4×4) block of pixels in the upper left corner of the current macroblock is based on replicating the four adjacent pixels in macroblock MB-A. Note that, if macroblock MB-A is not available, then the horizontal prediction mode cannot be used for that (4×4) block of pixels. FIG. 2(C) illustrates vertical prediction mode in which the prediction for the (4×4) block of pixels in the upper left corner of the current macroblock are based on the four adjacent pixels in macroblock MB-B. Note that, if macroblock MB-B is not available, then the vertical prediction mode cannot be used for that (4×4) block of pixels.

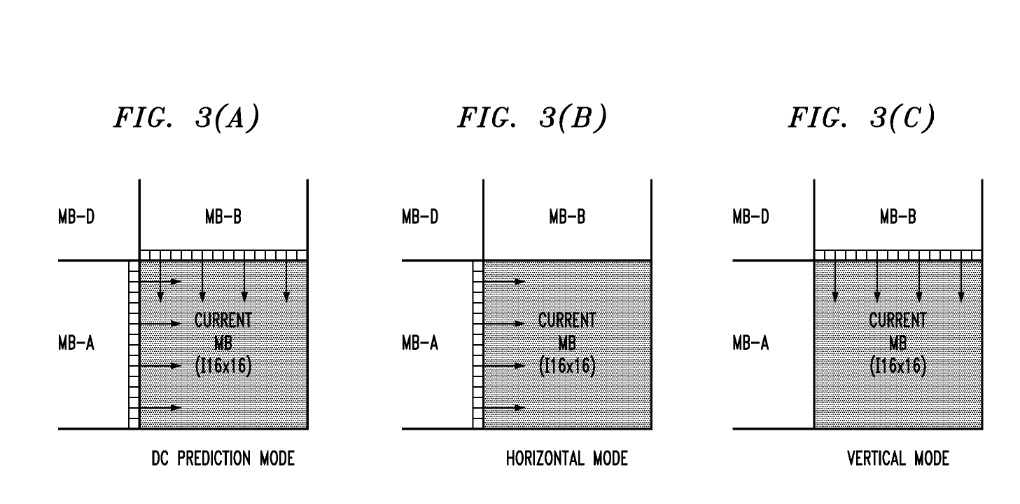

Similarly, FIG. 3 shows three different modes for predicting pixel data for I16×16-type macroblocks, where the (16×16) macroblock is encoded as a single (16×16) block of pixels. In particular, FIG. 3(A) illustrates DC prediction mode in which the prediction for the current macroblock is based on the average of the sixteen adjacent pixels in macroblock MB-A and the sixteen adjacent pixels in macroblock MB-B. Alternatives analogous to those for the I4×4 DC prediction mode exist for the I16×16 DC prediction mode if macroblock MB-A and/or macroblock MB-B are not available. FIG. 3(B) illustrates horizontal prediction mode in which the prediction for the current macroblock is based on replicating the sixteen adjacent pixels in macroblock MB-A. FIG. 3(C) illustrates vertical prediction mode in which the prediction for the current macroblock is based on replicating the sixteen adjacent pixels in macroblock MB-B. Analogous to I4×4 macroblocks, if macroblock MB-A or MB-B is not available, then horizontal or vertical prediction mode, respectively, cannot be used for the current macroblock.

### Encoding Using System 100

The following discussion applies to the (16×16) blocks of luma pixels of each macroblock in a picture. Note that each macroblock also includes two (8×8) blocks of chrome pixels, which can be handled in a manner analogous to the luma blocks.

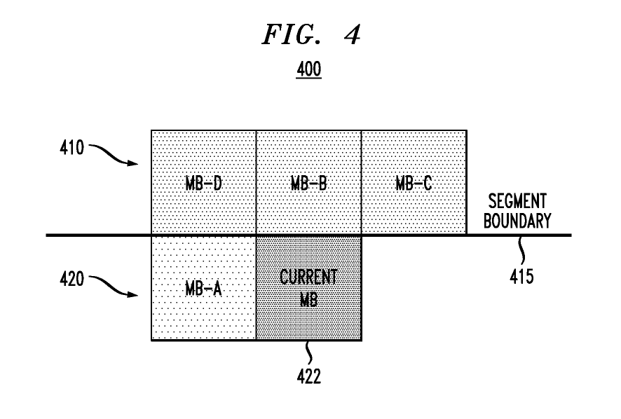

FIG. 4 shows a portion of an exemplary picture 400 containing macroblock 422. According to the H.264 standard, when macroblock 422 is the current MB being encoded, certain information for that current MB may be predicted from one or more of its four neighboring macroblocks MB-A, MB-B, MB-C, and MB-D, if available. This predicted information includes motion vectors for P and PSKIP macroblocks, Huffman code tables, intra modes for I macroblocks, and pixel data for I macroblocks.

Note that, if the current MB is in the first (i.e., top most) row of picture 400, then macroblocks MB-B, MB-C, and MB-D will not be available for use in predicting the current MB. Similarly, if the current MB is in the first (i.e., left most) column of picture 400, then macroblocks MB-A and MB-D will not be available for use in predicting the current MB. Note that, if the current MB is in the first row and the first column of picture 400, then none of the four neighboring MBs will be available for use in predicting the current MB. In each of these cases, the H.264 standard has special rules that determine how the current MB can be encoded.

In the particular situation depicted in FIG. 4, picture 400 is encoded using video encoding system 100 of FIG. 1, where N different initial video processors 120 are used to encode N different horizontal segments of picture 400 in parallel. In this situation, the current MB 422 is located in the first row of macroblocks immediately below a boundary 415 between two adjacent segments of picture 400. For this discussion, the segment above boundary 415 is referred to as upper segment 410, while the segment below the boundary is referred to as lower segment 420. The initial video processor 120 used to encode upper segment 410 is referred to as the upper processor, while the initial video processor 120 used to encode lower segment 420 is referred to as the lower processor. If upper segment 410 is the ith segment of picture 400, then the upper processor will be initial video processor 120_{—}i of FIG. 1, while the lower processor, which processes the (i+1)th segment of picture 400, will be initial video processor 120_(i+1) of FIG. 1. Note that a picture divided into N segments will have (N−1) boundaries separating (N−1) pairs of upper and lower segments. Note further that, for two consecutive boundaries, the lower segment for the upper boundary is the upper segment for the lower boundary.

In this situation, the upper processor begins to encode the first row of macroblocks (not shown in FIG. 4) in upper segment 410 at about the same time that the lower processor begins to encode the first row of macroblocks in lower segment 420, which first row includes MB-A and the current MB. As such, when the current MB is being encoded by the lower processor, the data from MB-A will be available for use in predicting information about the current MB, but the (e.g., motion vector, counts of quantized coefficients needed to determine the Huffman code tables, intra mode type, and reconstructed intra pixel) data from MB-B, MB-C, and MB-D will not yet be available, because the processing by the upper processor will not have reached those macroblocks yet. To handle that situation, the lower processor performs as much processing of the current MB as it can and then saves the partially encoded results of that initial processing in uncompressed form to the memory shared by the different processors. These results include the quantized transform coefficients, numbers of quantized coefficients in each sub-block (for eventual use in determining Huffman code tables), motion vector(s), macroblock type (i.e., predicted or non-predicted), P macroblock partition (e.g., P16×8, P8×8, P8×16, P16×16), and encoding mode(s) (e.g., P, PSKIP, I4×4, I16×16) for the current MB.

The H.264 standard also supports I8×8-type macroblocks, where the (16×16) macroblock is encoded as four (8×8) blocks of pixels. Although this type of macroblock does not have to be used, it behaves much the same as the I4×4 and I16×16 macroblock types.

When the processing by the upper processor eventually reaches the last row of upper segment 410, which includes MB-B, MB-C, and MB-D, the upper processor will have access to the stored results of the initial processing of the first row of lower segment 420. As described further below, based on those results, the upper processor will be able to complete the processing of the last row of upper segment 410 and store the results of its initial processing in the shared memory.

After the upper and lower processors have completed their respective processing of upper and lower segments 410 and 420, final video processor 130 of FIG. 1 will then complete the video encoding of picture 400. In particular, for each boundary 415 in picture 400, final video processor 130 will access the results of the initial processing by both the upper and lower processors stored in the shared memory in order to complete the processing of the first row of lower segment 420 to generate the outgoing, single-slice, compressed video bitstream 135 of FIG. 1. This processing may include predicting motion vectors for P and PSKIP macroblocks, predicting Huffman code tables, predicting intra modes for I macroblocks, and predicting pixel data for I macroblocks, all of which may now rely on available data from the corresponding upper segment 410 across boundary 415.

Final video processor 130 may also perform other conventional processing, such as the application of spatial de-blocking filters to reduce quantization effects. Note that, in other implementations, de-blocking filters can be applied by initial video processors 120. For segment 115_(i+1), the pixels and other information needed by the deblocking algorithm are not available from any MB coded in segment 115_{—}i, because processor 120_{—}i has not gotten that far yet. The deblocking algorithm can be performed in segment 115_(i+1) from the boundary, ignoring pixels from segment 115_{—}i. This causes some pixels in the top N_{d} pixel rows of segment 115_(i+1) to have incorrect values, where N_{d} is 7 for luma and 2 for chrome. However, the pixel value errors do not propagate any further than N_{d} pixel rows, regardless of any constraints. When processor 120_{—}i gets to the end of its segment, it can correct the N_{d} pixel rows below in segment 115_(i+1). Alternatively, this correction could be performed by final video processor 130. In neither case, are there any constraints on the deblocking filters. However, certain coding parameters, like quantization level, MB types, motion vectors, and the initial pre-filtered pixels needed by the deblocking filter algorithm need to be saved.

In one possible implementation of the present invention, the encoding of the last row of upper segment 410 by the upper processor and the encoding of the first row of lower segment 420 by the lower processor are constrained such that each processor is guaranteed to be able to complete the encoding processing of all of the rows of its segment, except possibly for the first row. Note that the very first processor (i.e., initial video processor 120_1 of FIG. 1) is capable of completing the encoding processing of all of the rows of its segment, because there are not other segments above its first row. As described further below, for predicted pictures, this ability of the lower processor to completely encode all but the first row is achieved by ensuring that data needed to encode the second row and any subsequent rows of lower segment 420 does not rely on any data (such as intra pixel values and motion vectors) from upper segment 410. As also described further below, for non-predicted pictures, this same result can be achieved by first encoding the macroblocks in the first column of picture 400 from the first row in the first segment of picture 400 down to the first row in the Nth segment of picture 400.

For each of the following constraints, it is assumed that the rules of the H.264 standard are also satisfied.

### Constraints for Predicted Pictures

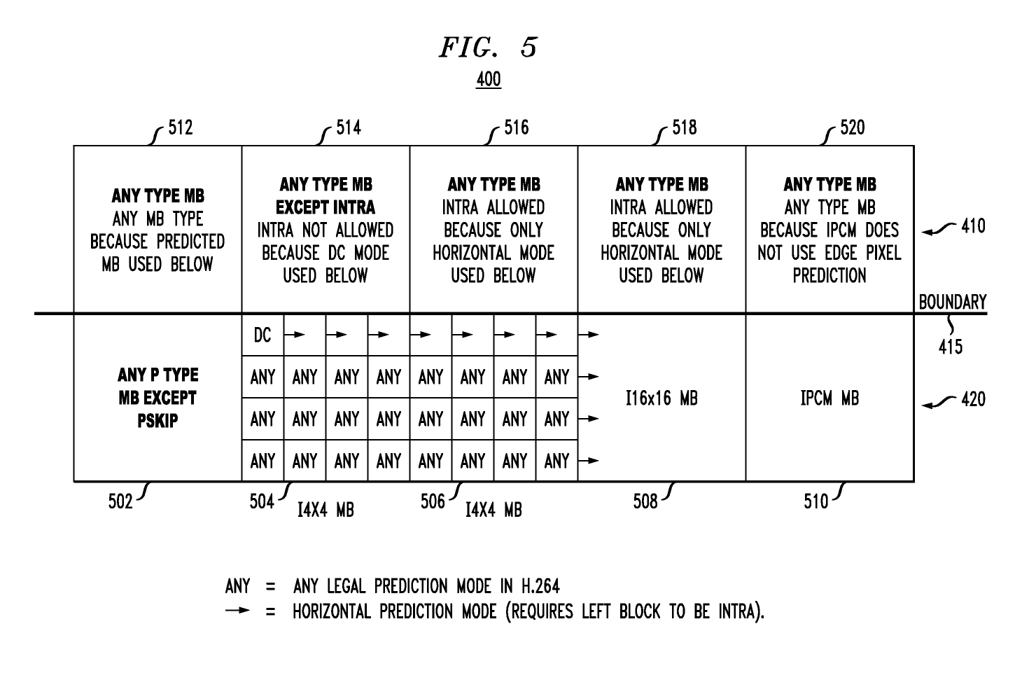

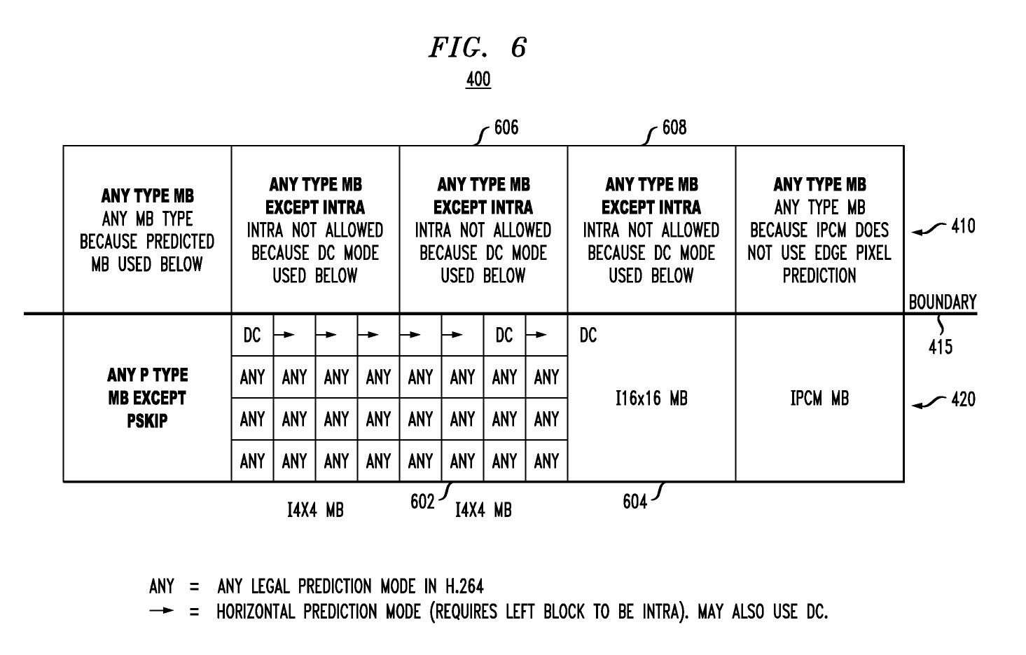

FIGS. 5 and 6 illustrate some of the constraints applied to the upper and lower processors when respectively encoding the last row of upper segment 410 and the first row of lower segment 420 for the case in which picture 400 is a predicted picture in which the H.264 flag constrained_intra_prediction_flag is set to 1. According to the H.264 standard, if constrained_intra_prediction_flag is set to 1, then intra macroblock pixels are not predicted from neighboring macroblocks unless those macroblocks are also intra macroblocks. If a neighboring macroblock is a predicted macroblock, then that neighboring predicted macroblock is declared to be unavailable for intra prediction of the current MB. If constrained_intra_prediction_flag is set to 0, then all neighboring MB types may be used for intra prediction of the current MB. Note that the encoding of each intermediate row (i.e., a row between the first row and the last row) of each segment is not constrained other than by the existing rules of the H.264 standard. Similarly, the encoding of the first row of the first (i.e., uppermost) segment in picture 400 and the encoding of the last row of the last (i.e., lowermost) segment in picture 400 are likewise not further constrained, because they are not adjacent to boundaries.

Note that, in FIGS. 5 and 6, each macroblock in the first row of lower segment 420 represents a different possible instance of the current MB of FIG. 4.

Constraint #1

A predicted macroblock in the first row of lower segment 420 can be encoded using any P mode except for PSKIP. PSKIP macroblocks have no bits transmitted in the output stream and no coefficients, but do have motion compensation applied to them. The motion vector for a PSKIP block is predicted from one or more neighboring macroblocks. Since a differential motion vector is not transmitted for PSKIP blocks, a corresponding H.264 decoder would have no differential data available to correct the predicted motion vector. If the first row of lower segment 420 had a PSKIP macroblock, then unknown motion vectors could propagate downward to the second row (or further). To avoid this situation, none of the predicted macroblocks in the first row of lower segment 420 are allowed to be PSKIP macroblocks. Instead, other P type macroblocks containing differential motion vectors may be used, even if those differential motion vectors signal no change from the predicted motion vector(s). This constraint is represented by macroblock 502 of FIG. 5.

Constraint #2

Except for the first column, a macroblock in the first row of lower segment 420 may be encoded using any of the following intra modes:
For an I4×4-type macroblock, each (4×4) block in the top row of (4×4) blocks in the macroblock can be encoded using any prediction mode that does not depend on pixels on the other side of boundary 415. Thus, vertical prediction mode is not allowed. Such a (4×4) block may be encoded using DC prediction mode (as illustrated in macroblock 504 of FIG. 5 and macroblock 602 of FIG. 1) or horizontal prediction mode (as illustrated in macroblocks 504 and 506 of FIG. 5). Note that, since the data above boundary 415 is not available, the DC prediction mode will be based only on pixels to the left of the (4×4) block (if available).
For an I4×4-type macroblock, each (4×4) block in any other row of (4×4) blocks in the macroblock can be encoded using any available prediction mode, as illustrated in macroblocks 504 and 506 of FIG. 5 and macroblock 602 of FIG. 6.
For an I16×16-type macroblock, the macroblock can be encoded using any prediction mode that does not depend on pixels on the other side of boundary 415. Thus, vertical prediction mode is not allowed. Such a macroblock may be encoded using DC prediction mode (as illustrated in macroblock 604 of FIG. 6) or horizontal prediction mode (as illustrated in macroblock 508 of FIG. 5). Note that, since the data above boundary 415 is not available, the DC prediction mode will be based only on pixels to the left of the macroblock (if available).
The macroblock can be encoded as an IPCM (intra pulse code modulation) macroblock (as illustrated in macroblock 510 of FIG. 5), since IPCM macroblocks do not use prediction from neighbors.

Constraint #3

The macroblock in the first column and the first row of lower segment 420 may be encoded using any of the following intra modes:
For an I4×4-type macroblock, the left-most (4×4) block in the first row of the macroblock is encoded using DC prediction mode, since no data is available from the left for horizontal prediction mode. The other three (4×4) blocks in the first row can be encoded using DC prediction mode or horizontal prediction mode. Note that, since the data above boundary 415 is not available, the DC prediction mode for the left-most (4×4) block in the first row of the macroblock will be based on the H.264 default value (e.g., 128).
For an I4×4-type macroblock, each (4×4) block in any other row of (4×4) blocks in the macroblock can be encoded using any available prediction mode.
For an I16×16-type macroblock, the macroblock is encoded using DC prediction mode, since no data is available from the left for horizontal prediction mode. Note that, since the data above boundary 415 is also not available, the DC prediction mode for the macroblock will be based on the H.264 default value (e.g., 128).
The macroblock can be encoded as an IPCM macroblock since IPCM macroblocks do not use prediction from neighbors.

Constraint #4

The encoding of a macroblock in the last row of upper segment 410 is constrained as follows:
If any (4×4) block in the first row of an I4×4 macroblock directly below and across boundary 415 is encoded using DC prediction mode, then the corresponding macroblock in the last row of upper segment 410 can be encoded as any type except intra. This is illustrated in macroblock 514 of FIG. 5 and macroblock 606 of FIG. 6.
If an I16×16 macroblock directly below and across boundary 415 is encoded using DC prediction mode, then the corresponding macroblock in the last row of upper segment 410 can be encoded as any type except intra. This is illustrated in macroblock 608 of FIG. 6.
Macroblocks 512, 516, 518, and 520 of FIG. 5 illustrate that the encoding of macroblocks in the last row of upper segment 410 are not constrained for any other types of macroblocks directly below and across boundary 415.

### Constraints for Non-Predicted Pictures

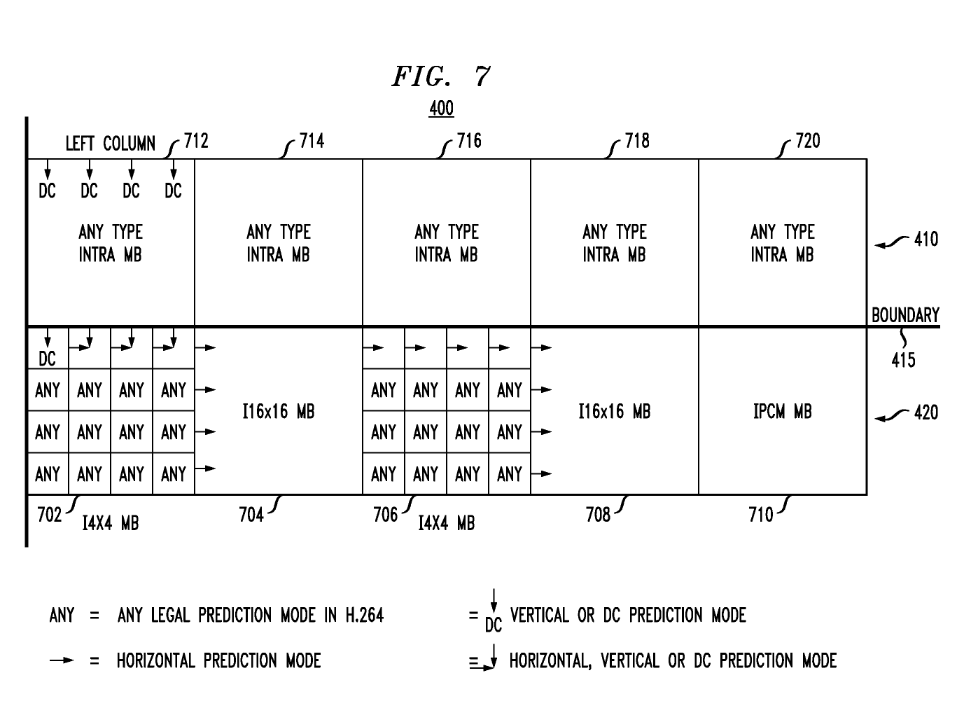

FIG. 7 illustrates some of the constraints applied to the upper and lower processors when respectively encoding the last row of upper segment 410 and the first row of lower segment 420 for the case in which picture 400 is a non-predicted picture. In a non-predicted picture, each macroblock is encoded as an intra macroblock. As in FIGS. 5 and 6, in FIG. 7, each macroblock in the first row of lower segment 420 represents a different possible instance of the current MB of FIG. 4.

Constraint #1

Except for the first column, a macroblock in the first row of lower segment 420 may be encoded using any of the following intra modes:
For an I4×4-type macroblock, each (4×4) block in the top row of (4×4) blocks in the macroblock can be encoded using any prediction mode that does not depend on pixels on the other side of boundary 415. Thus, vertical prediction mode is not allowed. Such a (4×4) block may be encoded using horizontal prediction mode (as illustrated in macroblock 706 of FIG. 7).
For an I4×4-type macroblock, each (4×4) block in any other row of (4×4) blocks in the macroblock can be encoded using any available prediction mode, as illustrated in macroblock 706 of FIG. 7.
For an I16×16-type macroblock, the macroblock can be encoded using any prediction mode that does not depend on pixels on the other side of boundary 415. Thus, vertical prediction mode is not allowed. Such a macroblock may be encoded using horizontal prediction mode (as illustrated in macroblocks 704 and 708 of FIG. 7).
The macroblock can be encoded as an IPCM macroblock (as illustrated in macroblock 710 of FIG. 7), since IPCM macroblocks do not use prediction from neighbors.

Constraint #2

In FIG. 7, macroblocks 702 and 712 are the left-most macroblocks in the first row of lower segment 420 and the last row of upper segment 410, respectively. In other words, they are both in the first column of picture 400. According to the H.264 standard, the first pixels in a macroblock at the left edge of a picture may be encoded using either DC or vertical prediction mode. For an I4×4 macroblock, the first pixels correspond to the upper left (4×4) block, as illustrated in macroblock 702 of FIG. 7. For an I16×16 macroblock, the first pixels correspond to the entire macroblock, as illustrated in macroblock 712 of FIG. 7.

In order to support both DC and vertical prediction modes for the first pixels of a first-column macroblock (except for the macroblock in the upper left corner of picture 400 for which vertical prediction mode is not allowed by the H.264 standard, because it has no available neighboring MB), in certain embodiments of video encoding system 100 of FIG. 1, the macroblocks in the first column from the first row in picture 400 down to the last row of the (N−1)th segment (i.e., the next-to-last segment) are initially encoded to the point where the coded macroblocks are reconstructed (i.e., using quantized coefficients). This can be achieved by having initial video processor 120_1 for the first (i.e., uppermost) segment in picture 400 sequentially generate (i.e., from the first row to the last row in the first segment) reconstructed pixels for its left-most macroblocks, followed by initial video processor 120_2 for the second segment in picture 400 sequentially generating reconstructed pixels for its left-most macroblocks, and so on until initial video processor 120_(N−1) for the next-to-last segment in picture 400 sequentially generates reconstructed pixels for its left-most macroblocks, all before initial video processor 120_N begins to process the last (i.e. lowermost) segment in picture 400.

This constraint of sequentially generating reconstructed pixels for macroblocks in the first column at the start of a picture's processing will add a little latency to the parallel processing of system 100, but that latency can be reduced by initiating parallel processing as soon as possible. In particular, after initial video processor 120_1 finishes generating reconstructed pixels for the left-most macroblock in the last row of the first segment in picture 400, initial video processor 120_1 can immediately continue its processing of the rest of the first segment, e.g., while initial video processor 120_2 processes the left-most macroblocks in the second segment in picture 400. Similarly, after initial video processor 120_2 finishes generating reconstructed pixels for the left-most macroblock in the last row of the second segment in picture 400, initial video processor 120_2 can immediately continue its processing of the rest of the second segment, e.g., while initial video processor 120_3 processes the left-most macroblocks in the third segment in picture 400, and so on.

Note that, in general, when initial video processor 120_{—}i is processing one of its left-most macroblocks, the neighboring macroblock to the upper right (i.e., corresponding to MB-C in FIG. 4) will not yet have been encoded. As such, the prediction modes for each left-most macroblock are restricted to avoid prediction from the upper right.

Other than the initial processing of macroblocks in the first column described in Constraint #2, there are no other restrictions on the processing of macroblocks in the last row of upper segment 410, as illustrated in macroblocks 712-720 of FIG. 7.

### Broadening

Although the present invention has been described in the context of handling certain aspects of the H.264 standard, the present invention can be extended to handle other aspects of the H.264 standard, for example, when the H.264 flag constrained_intra_prediction_flag is set to 0 or for macroblocks encoded using I8×8-type intra modes. Additionally, the present invention can be extended to B-type (or bi-directionally predicted) pictures, which use other macroblock types in addition to P type macroblocks. The present invention can also be applied to interlaced pictures, which are comprised of fields. Each picture frame is divided into fields of even or odd pixel rows. In interlaced pictures, macroblocks may cover a (16×16) area of a field (and thus a (16×32) area of the combined picture frame) or a pair of macroblocks may cover a (16×32) area of the picture frame.

Although the present invention has been described in the context of encoding in which constraints are applied to only the last rows of upper segments and the first rows of lower segments such that the encoding of all rows except for the first rows of lower segments can be completed by the initial video processors, in alternative embodiments, different constraints can be applied such that all rows except for the first two or more rows of lower segments can be completed by the initial video processors. Such different constraints can be designed to provide greater compression and/or less data loss at the expense of greater latency, resulting from more processing being required to be performed by the final video processor.

Although the present invention has been described in the context of the H.264 video encoding standard, the present invention can be alternatively implemented in the context of video encoding corresponding to standards other than H.264.

Although the present invention has been described in the context of encoding a video signal having a sequence of pictures, the present invention can also be applied to the encoding of individual pictures, where each individual picture is encoded as a non-predicted picture.

The present invention may be implemented as (analog, digital, or a hybrid of both analog and digital) circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. The present invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The present invention can also be embodied in the form of a bitstream or other sequence of signal values stored in a non-transitory recording medium generated using a method and/or an apparatus of the present invention.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A system (e.g., 100) for encoding single-slice pictures, the system comprising:
(a) a plurality of initial processors (e.g., 120), each initial processor adapted to process a different horizontal segment (e.g., 115) of a picture (e.g., 105), wherein at least one initial processor of a segment in the picture only partially encodes the segment; and
(b) a final processor (e.g., 130) that completes the encoding of each partially encoded segment (e.g., 125) to produce a single-slice encoded picture (e.g., 135).

2. The invention of claim 1, wherein the initial processors and the final processor are implemented by multiple cores of a single integrated circuit.

3. The invention of claim 1, wherein the plurality of initial processors are mutually parallel processors having shared memory.

4. The invention of claim 1, wherein:
the picture is part of an uncompressed video stream; and
the single-slice encoded picture is part of a compressed, single-slice video bitstream.

5. The invention of claim 4, wherein the compressed, single-slice video bitstream conforms to an H.264 video standard.

6. The invention of claim 1, wherein the system further comprises a divider (e.g., 110) that divides the picture horizontally into the plurality of segments.

7. The invention of claim 1, wherein:
the picture comprises N horizontal segments, where N is an integer greater than one;
the plurality of initial processors comprises a first initial processor (e.g., 120_1) for the first segment in the picture and (N−1) other initial processors (e.g., 120_2 to 120_N) for the (N−1) other segments in the picture;
the first initial processor completely encodes the first segment;
the (N−1) other initial processors only partially encode the (N−1) other segments; and
the final processor completes the encoding of the (N−1) partially encoded, other segments.

8. The invention of claim 7, wherein:
each other initial processor completely encodes all macroblock rows in the corresponding other segment except for the first macroblock row; and
the final processor completes the encoding of the first macroblock row of each other segment.

9. The invention of claim 8, wherein:
each other initial processor generates and stores data corresponding to one or more of quantized transform coefficients, numbers of quantized transform coefficients in each sub-block, motion vectors, macroblock type, P macroblock partition, and encoding modes for the corresponding first macroblock row; and
the final processor accesses the stored data to generate one or more of predicted pixel data, predicted motion vectors, predicted Huffman code tables, and predicted encoding modes for each first corresponding macroblock row based on data from another segment of the picture.

10. The invention of claim 1, wherein, for each boundary (e.g., 415) between adjacent segments in the picture, constraints are applied to the encoding of macroblocks in the last row of an upper segment (e.g., 410) immediately above the boundary and to the encoding of macroblocks in the first row of a lower segment (e.g., 420) immediately below the boundary to enable the second row of the lower segment to be completely encoded by the corresponding initial processor.

11. The invention of claim 10, wherein the constraints prevent errors from propagating beyond the first row of the lower segment.

12. The invention of claim 10, wherein, for a predicted picture, the constraints include forbidding any macroblock in the first row of the lower segment from being encoded as a PSKIP macroblock (e.g., 502).

13. The invention of claim 10, wherein, for a predicted picture, the constraints include forbidding any pixel data in the lower segment (e.g., 504, 506, 508, 602, 604) from being intra predicted using any pixel data from the upper segment.

14. The invention of claim 10, wherein, for a predicted picture, the constraints include forbidding a macroblock in the last row of the upper segment (e.g., 514, 606, 608) from being encoded as an intra macroblock if any uppermost pixels in the immediately below macroblock in the first row of the lower segment (e.g., 504, 602, 604) are encoded using a DC prediction mode.

15. The invention of claim 10, wherein, for a non-predicted picture, the constraints include at least partially encoding each macroblock in the first column of the picture (e.g., 702, 712) for all but the bottommost segment in the picture prior to encoding any of the bottommost segment.

16. The invention of claim 1, wherein:
the initial processors and the final processor are implemented by multiple cores of a single integrated circuit;
the plurality of initial processors are mutually parallel processors having shared memory;
the picture is part of an uncompressed video stream;
the single-slice encoded picture is part of a compressed, single-slice video bitstream that conforms to an H.264 video standard;
the system further comprises a divider (e.g., 110) that divides the picture horizontally into the plurality of segments;
the picture comprises N horizontal segments, where N is an integer greater than one;
the plurality of initial processors comprises a first initial processor (e.g., 120_1) for the first segment in the picture and (N−1) other initial processors (e.g., 120_2 to 120_N) for the (N−1) other segments in the picture;
the first initial processor completely encodes the first segment;
the (N−1) other initial processors only partially encode the (N−1) other segments;
the final processor completes the encoding of the (N−1) partially encoded, other segments;
each other initial processor completely encodes all macroblock rows in the corresponding other segment except for the first macroblock row;
the final processor completes the encoding of the first macroblock row of each other segment;
each other initial processor generates and stores data corresponding to one or more of quantized transform coefficients, numbers of quantized transform coefficients in each sub-block, motion vectors, macroblock type, P macroblock partition, and encoding modes for the corresponding first macroblock row;
the final processor accesses the stored data to generate one or more of predicted pixel data, predicted motion vectors, predicted Huffman code tables, and predicted encoding modes for each first corresponding macroblock row based on data from another segment of the picture;
for each boundary (e.g., 415) between adjacent segments in the picture, constraints are applied to the encoding of macroblocks in the last row of an upper segment (e.g., 410) immediately above the boundary and to the encoding of macroblocks in the first row of a lower segment (e.g., 420) immediately below the boundary to enable the second row of the lower segment to be completely encoded by the corresponding initial processor;
the constraints prevent errors from propagating beyond the first row of the lower segment;
for a predicted picture, the constraints include:
(i) forbidding any macroblock in the first row of the lower segment from being encoded as a PSKIP macroblock (e.g., 502);
(ii) forbidding any pixel data in the lower segment (e.g., 504, 506, 508, 602, 604) from being intra predicted using any pixel data from the upper segment; and
(iii) forbidding a macroblock in the last row of the upper segment (e.g., 514, 606, 608) from being encoded as an intra macroblock if any uppermost pixels in the immediately below macroblock in the first row of the lower segment (e.g., 504, 602, 604) are encoded using a DC prediction mode; and
for a non-predicted picture, the constraints include at least partially encoding each macroblock in the first column of the picture (e.g., 702, 712) for all but the bottommost segment in the picture prior to encoding any of the bottommost segment.

17. A method (e.g., 100) for encoding single-slice pictures, the method comprising:
(a) initially processing (e.g., 120) each different horizontal segment (e.g., 115) of a picture (e.g., 105), wherein at least one initial processing of a segment in the picture only partially encodes the segment; and
(b) finally processing (e.g., 130) to complete the encoding of each partially encoded segment (e.g., 125) to produce a single-slice encoded picture (e.g., 135).

18. Apparatus (e.g., 100) for encoding single-slice pictures, the apparatus comprising:
(a) means for initial processing (e.g., 120) of each different horizontal segment (e.g., 115) of a picture (e.g., 105), wherein at least one means for initial processing of a segment in the picture only partially encodes the segment; and
(b) means for final processing (e.g., 130) to complete the encoding of each partially encoded segment (e.g., 125) to produce a single-slice encoded picture (e.g., 135).
